(19) United States
(12) Patent Application Publication
(10) Pub. No.: US 2012/0228104 A1
(43) Pub. Date: Sep. 13, 2012

(54) SOLAR CELL INSTALLATION

(76) Inventor: William John Kirkham, Cranebrook (AU)

(21) Appl. No.: 13/246,330

(22) Filed: Sep. 27, 2011

(30) Foreign Application Priority Data
Mar. 7, 2011 (AU) 2011 900 984

(51) Int. Cl. H01H 17/16; H01H 11/00

(52) U.S. Cl. 200/337; 29/622

(57) ABSTRACT

The disconnection mechanism 116 is disclosed to disconnect solar cells 5, 105 from high voltage DC cables 13, 113 which may run through the interior of a building 1 and thus represent a hazard to emergency service personnel such as firemen attending a fire in daylight hours. Thus the DC output from the cells 5, 105 can be rendered safe. The mechanism is located in an elevated position adjacent the solar cells 5, 105 but is operable by an elongated actuator 19, 119 which extends to ground level. Preferably the solar cells are individually connected via corresponding cables 223 to a terminal block 118 within a fireproof housing 117 for the disconnect mechanism 116.

### CROSS REFERENCE TO RELATED APPLICATIONS

This application claims priority from Australian Patent Application Serial No. 2011 900 984 filed on Mar. 7, 2011.

### BACKGROUND OF THE INVENTION

The present invention relates to the installation of solar cells and, in particular, to the installation of solar cells in a manner which is safe in the event of a fire engulfing the structure on which solar cells are mounted.

Solar cells need to be mounted so as to receive solar radiation and for this reason are often mounted on the roof of a building. Irrespective of whether the building has one or more stories, the roof is at an elevated position which is generally difficult to access. The solar cells generate a DC output and are connected by means of a DC cable to an inverter which converts the DC output (typically 400V DC and up to approximately 15 amps) into an AC output (typically 240V or 110V) which is either used within the building or is injected into an AC mains supply. The inverter and the AC switchboard, with which it is connected, are generally located at ground level at a position which is able to be accessed in a convenient manner. Depending upon the nature of the building and the installation, the DC cable often extends through the roof cavity of the building, through cavities between walls, and the like. The route of the DC cable is generally not marked and very often the cable will have been installed after the building has been constructed.

In the event of a fire, the fire brigade personnel arriving at the building will disconnect the wiring of the building from the AC mains supply, if this has not already been done by an occupant of the building or some other person who has raised the fire alarm. However, during the daylight hours, the output of the solar cells will continue to be produced notwithstanding that a fire may be raging within the building. As a consequence, the fire brigade personnel attending the fire are potentially exposed to an electrical hazard in the form of the energized DC cable which will remain energized until such time the solar cells are effectively destroyed by the fire.

The genesis of the present invention is a desire to reduce the exposure of firemen and such emergency personnel to DC electrical hazards caused by the presence of solar cells mounted on buildings and similar structures.

### SUMMARY OF THE INVENTION

In accordance with a first aspect of the present invention there is disclosed a solar cell installation comprising at least one solar cell mounted in an elevated position to receive solar radiation, said solar cell having a DC output connected via a DC cable to an inverter to convert said DC output into an AC output, wherein a cut-out switch is located in an elevated position adjacent said solar cell(s) and is operable to disconnect said DC output from said DC cable, and wherein said cut-out switch adjacent said elevated position is operable by an elongated actuator which extends from said cut-out switch to an un-elevated position at, or near, ground level.

In accordance with a second aspect of the present invention there is disclosed a method of isolating at least one solar cell mounted in an elevated position to receive solar radiation and producing a DC output, said method comprising: interposing a cut-out switch in a DC cable interconnecting said solar cells with an inverter to produce an AC output, said cut-out switch being located in an elevated location adjacent said solar cells and being operable to disconnect said DC output from said DC cable, connecting said cut-out switch to an elongated actuator which extends from said cut-out switch to an un-elevated position at, or near, ground level, and operating said actuator to disconnect said DC cable from said solar cell.

In accordance with a third aspect of the present invention there is disclosed a cut-out switch operable remotely by an elongated actuator, said switch comprising a fireproof housing, a switch located inside said housing, and an elongated actuator having two ends, one end being connected with said switch to open and close same and the other end of said actuator having an operating handle means.

In accordance with a fourth aspect of the present invention there is disclosed a solar cell installation including the abovementioned cut-out switch.

### BRIEF DESCRIPTION OF THE DRAWINGS

The present invention will hereinafter be described in conjunction with the appended drawing figures wherein like numerals denote like elements.

FIG. 1 is a perspective view of a two story building having a roof upon which solar cells are mounted and isolated in accordance with a first embodiment;

FIG. 2 is a schematic cross-sectional view showing the mounting of the solar cells of FIG. 1 and the operation of the actuator to disconnect same;

FIG. 3 is a perspective view of the open housing in which the cut-out switch of FIGS. 1 and 2 is mounted;

FIG. 4 is a perspective view of a two story building having a roof upon which solar cells are mounted and isolated in accordance with a second embodiment;

FIG. 5 is a schematic perspective view of the open housing in which the cut-out switch of the second embodiment is mounted;

FIG. 6 is a perspective view of the lower end of the actuator; and

FIG. 7 is a view similar to FIG. 5 but showing the cut-out switch opened.

### DETAILED DESCRIPTION OF THE PREFERRED EMBODIMENTS

The ensuing detailed description provides preferred exemplary embodiments only, and is not intended to limit the scope, applicability, or configuration of the invention. Rather, the ensuing detailed description of the preferred exemplary embodiments will provide those skilled in the art with an enabling description for implementing the preferred exemplary embodiments of the invention. It being understood that various changes may be made in the function and arrangement of elements without departing from the spirit and scope of the invention, as set forth in the appended claims.

To aid in describing the invention, directional terms are used in the specification and claims to describe portions of the present invention (e.g., upper, lower, left, right, etc.). These directional definitions are merely intended to assist in describing and claiming the invention and are not intended to limit the invention in any way. In addition, reference numerals that are introduced in the specification in association with a drawing figure may be repeated in one or more subsequent figures without additional description in the specification in order to provide context for other features.

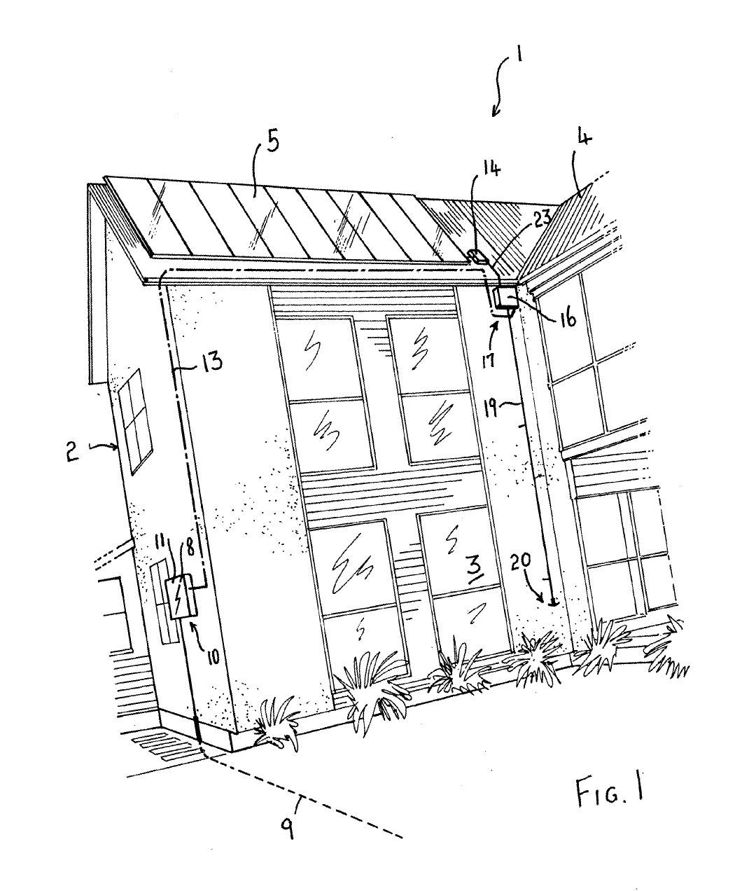

As seen in FIG. 1, a building 1 has an upper story 2 and a ground floor 3. The upper story 2 has a roof 4 upon which a number of solar cells 5 are mounted so as to receive solar radiation.

Mounted at ground level is an inverter 8 which is connected to an AC mains supply 9 which takes the form of an underground cable which leads to a housing 10 which includes both the inverter 8 and an AC switchboard 11. A DC cable 13 interconnects the inverter 8 with a junction box 14 located adjacent the solar cells 5. In the prior art the junction box 14 and the DC cable 13 are directly connected and so the DC cable 13 is always energized for so long as solar radiation falls on the solar cells 5.

In the prior art, this has the consequence that in the event of a fire, even though the AC switchboard 11 may be disconnected from the AC mains supply 9, the DC cable 13 which runs through the roof cavity and a wall cavity is still energized with the output of the solar cells.

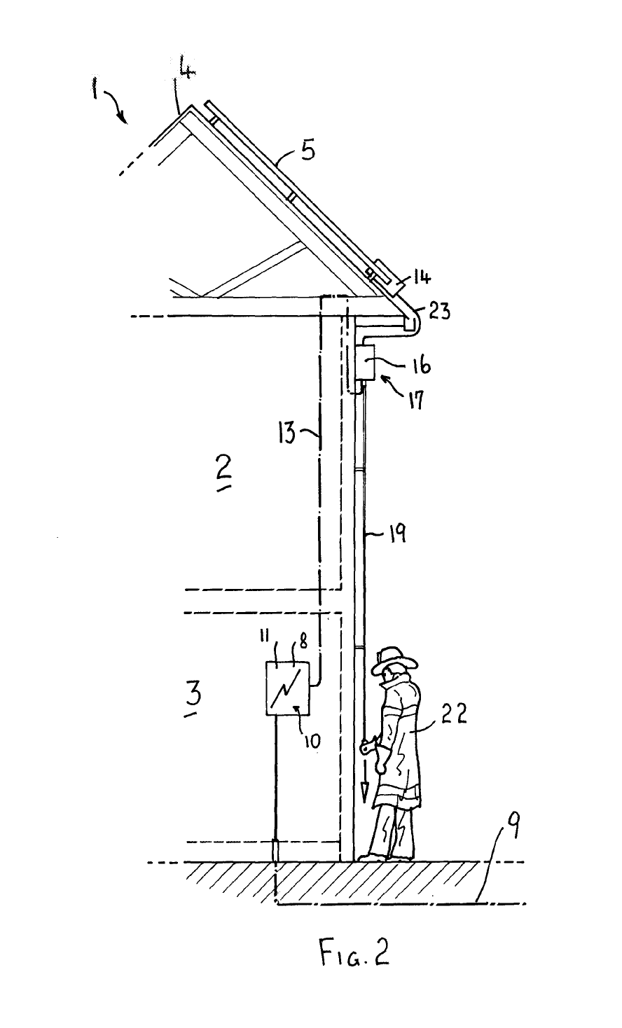

In order to overcome this problem in accordance with the first embodiment of the present invention, a cut-out switch 16 having a housing 17 is mounted under the eave of the roof 4. The housing 17 is therefore in an elevated position but is provided with an elongated actuator 19 having a handle 20 which is able to be operated by a fireman 22 (FIG. 2) at ground level so as to disconnect the DC cable 13 from the output of the solar cells 5.

It will be apparent from FIG. 2 that the DC cable 13 extends through the interior of the building 1 and, if not de-energized, represents an electrical hazard to emergency personnel such as the fireman 22 called to fight a fire, for example.

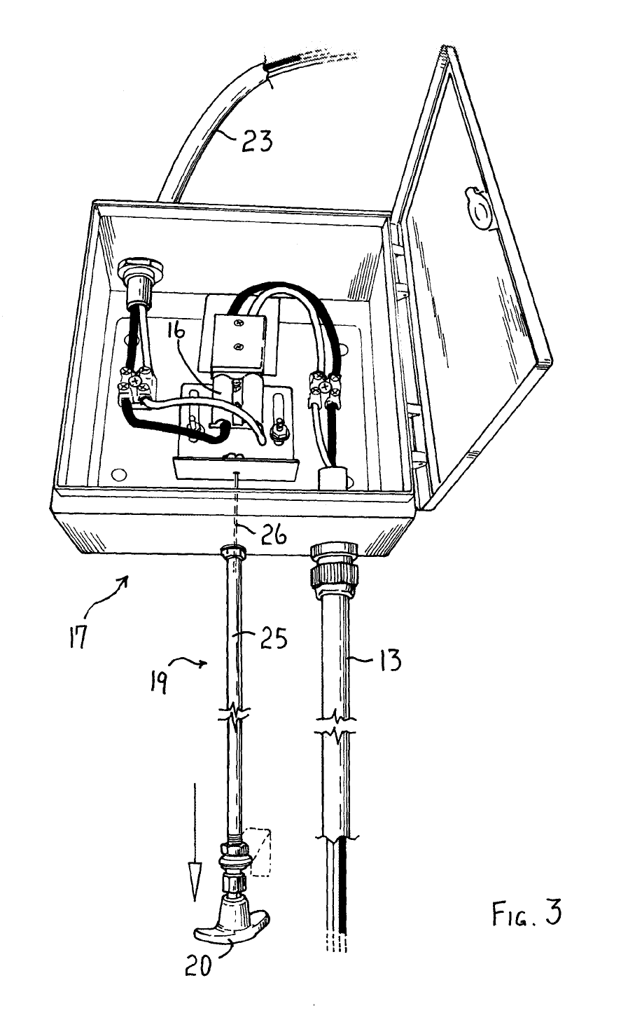

Turning now to FIG. 3, the housing 17 and cut-out switch 16 are illustrated. The housing 17 is preferably fire resistant and contains terminals to which are connected the DC cable 13 on one side, and the solar cell cable 23 on the other side. The DC cable 13 is preferably fire rated. The elongated actuator 19 comprises a Bowden cable, or similar, having an outer sleeve 25 and an inner cable 26, the lower end of which is connected to the handle 20. It will be apparent that pulling the handle 20 downwardly disconnects the solar cell cable 23 from the DC cable 13.

Preferably, in this embodiment, pushing the handle upwardly does not reconnect the two cables. Thus only disconnection can take place from ground level thereby rendering the interior of the building 1 undoubtedly safe once the disconnection has taken place. Furthermore, the handle 20 in the pulled down position provides a non-transient mechanical signal that the solar cells have been isolated. In addition, the mechanical actuator 19 can be relied upon to function reliably notwithstanding the heat of any fire.

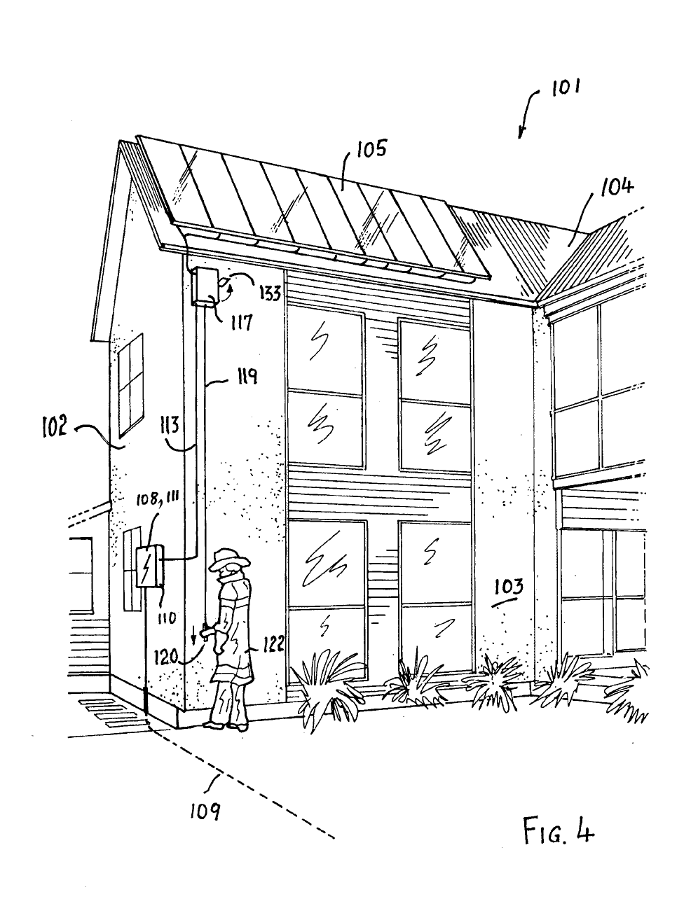

Turning now to FIGS. 4-7, in the description of the second embodiment, like components have been allocated a designation number increased by 100 relative to the description of the first embodiment in relation to FIGS. 1-3.

As seen in FIG. 4, as before building 101 has an upper story 102 and a ground floor 103. The upper story 102 has a roof 104 upon which a number of solar cells 105 are mounted so as to receive solar radiation.

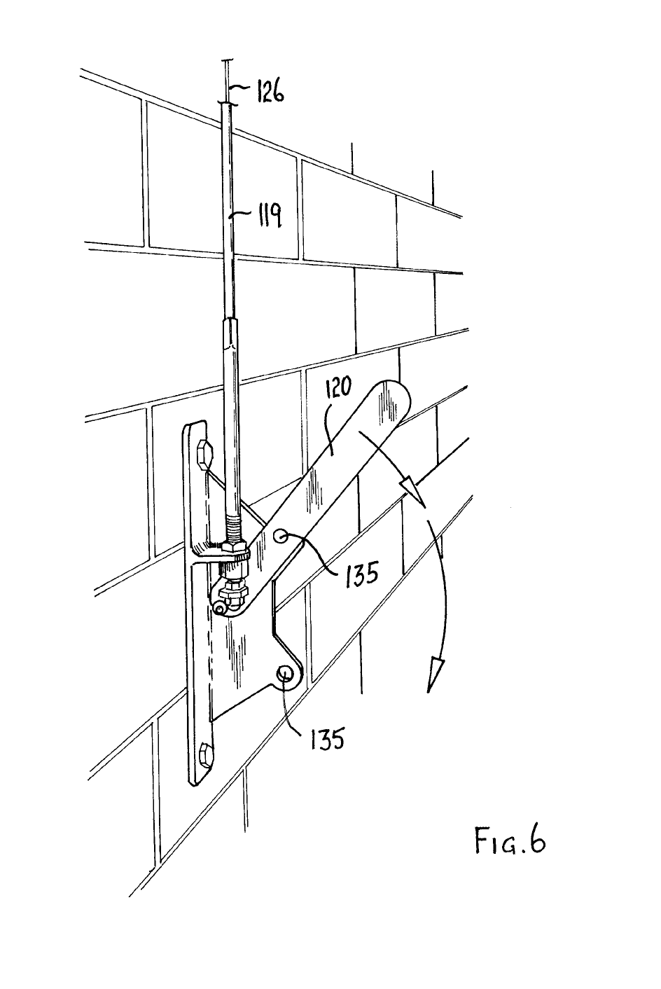

Mounted at ground level is an inverter 108 which is connected to an AC mains supply 109 which takes the form of an underground cable which leads to a housing 110 which includes both the inverter 108 and an AC switchboard 111. A DC cable 113 interconnects the inverter 108 with a housing 117. Located within the housing 117 is a cut-out switch 116. The housing 117 is in an elevated position and is provided with an elongated actuator 119 having a handle 120 (illustrated in more detail in FIG. 6) and which is able to be operated by a fireman 122 (FIG. 4) at ground level so as to disconnect the DC cable 113 from the output of the solar cells 105.

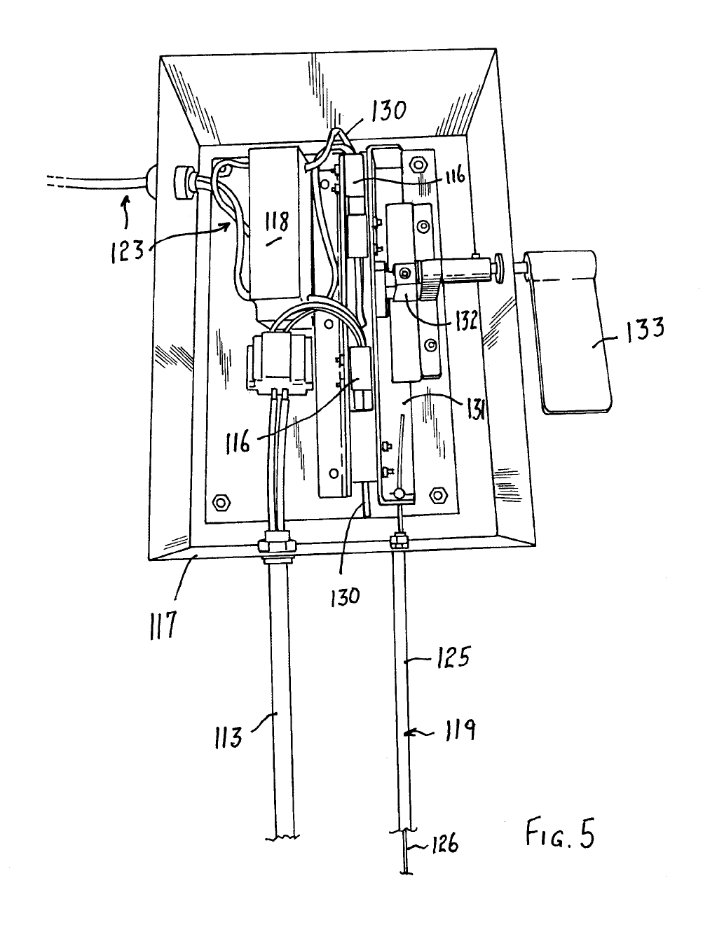

Turning now to FIG. 5, the housing 117 and cut-out switch 116 are illustrated. The housing 117 is preferably fire resistant and contains a terminal block 118 to which are connected a DC high voltage cable 130 on one side, and the solar cell cable(s) 123 on the other side.

There are two possible ways of connecting the solar cells 105. Traditionally, such cells have been connected together in series so that the solar cell cable 123 leading into the housing 117 carries a maximum DC voltage (and hence a minimum current). Under these circumstances, the solar cell cable 123 and the DC high voltage cable 130 have the same voltage and are simply connected together at the terminal block 118.

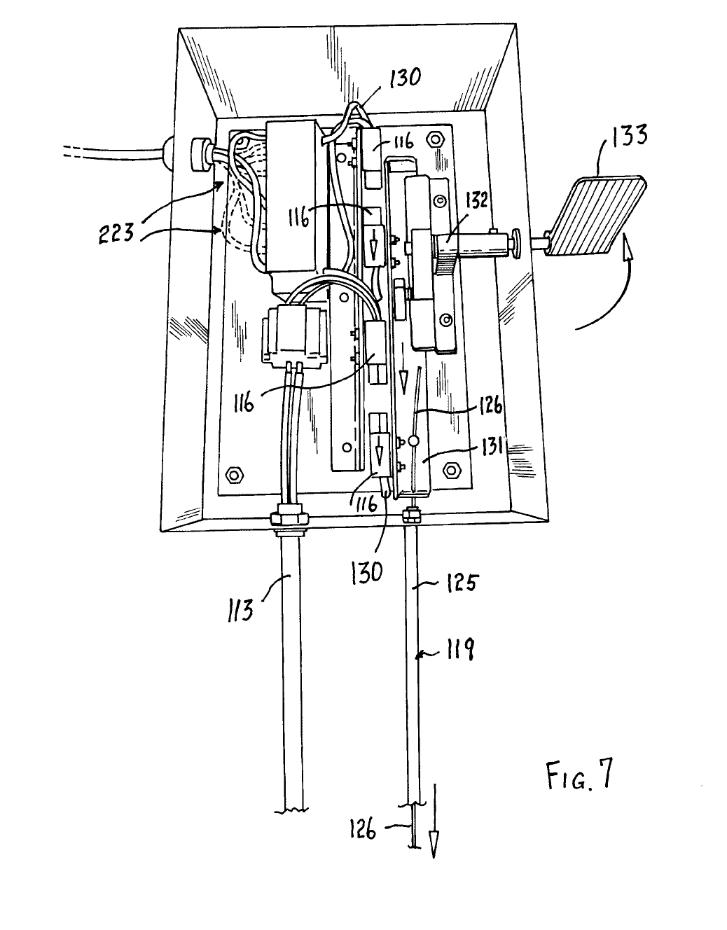

An alternative way of connecting the solar cells 105, which is much to be preferred, is that each cell 105 has an individual cable as illustrated in FIG. 4 and that all the individual cables 223 are terminated at the terminal block 118. This arrangement is indicated by broken lines in FIG. 7. Under these circumstances, the individual solar cell cables 223 each carry the individual cell voltage and it is only the DC high-voltage cable 130 and the DC cable 113 which are at the high DC voltage. This provides an additional safety benefit. The solar cell cable(s) 123, 223 and the DC cables 113 and 130 are preferably fire rated.

The elongated actuator 119 comprises a Bowden cable, or similar, having an outer sleeve 125 and an inner cable 126 the lower end of which is connected to the handle 120. The inner cable 126 is connected to the lower part of a double pole cut-out switch 116 via a plate 131. A cam 132 is also mounted on the plate 131 so as to rotate a pivoted flag 133. With the handle 120 of FIG. 6 in the upward position illustrated in FIG. 6, the cut-out switch 116 is connected as illustrated in FIG. 5, and the flag 133 points vertically downwards. However, pulling the handle 120 downwardly as seen in FIG. 6 moves the plate 131 of FIG. 5 downwardly thereby opening the double pole cut-out switch 116 and rotating the flag 133 into a horizontal position as seen in FIG. 7 (and in FIG. 4). As a consequence, the solar cells 105 are disconnected from the DC cable 113. Further, the flag 133 has one side painted differently from the other so as to clearly indicate the disconnection to those at ground level.

It will be apparent that in this embodiment, pushing the handle 120 upwardly does reconnect the cut-out switch 116 and thus does reconnect the two cables 113 and 130. However, the flag 133 is, under these circumstances, rotated back to the vertical position illustrated in FIG. 5 and thus the re-connection is apparent. As seen in FIG. 6, the handle 120 includes holes 135 adapted to enable the handle 120 to be locked in the cable disconnected position. As before, the inner cable 126 can be relied upon to function reliably, notwithstanding the heat of any fire.

As seen in FIG. 4, both the DC cable 113 and the solar cell cables 123 do not extend through the interior of the building 100 and thus do not constitute an electrical hazard to any emergency personnel such as the fireman 122 called to fight a fire, for example, and who enter the interior of the building. However, this desirable wiring practice will not be previously known, in general, to such emergency personnel.

The foregoing describes only two embodiments of the present invention and modifications, obvious to those skilled in the fire fighting arts, can be made thereto without departing from the scope of the present invention.

For example, the junction box 14 can be located between the roof 4 and the solar cells 5, or can be located within the ceiling cavity below the roof. Similarly, the cut-out switch housing 17 can be located between the roof 4 and the solar cells 5, or can be located in the ceiling cavity. If the housing 17 is located within the building, the actuator 19 can be located within the building also, or can extend through an eave or wall to the exterior of the building. Furthermore, the actuator 119 is preferably arranged to have its handle 120 located adjacent the inverter 108 and AC switchboard 111, as illustrated in FIG. 4, so that all electrical controls are close to each other.

The term “comprising” (and its grammatical variations) as used herein is used in the inclusive sense of “including” or “having” and not in the exclusive sense of “consisting only of”.

While the principles of the invention have been described above in connection with preferred embodiments, it is to be clearly understood that this description is made only by way of example and not as a limitation of the scope of the invention.

1. A solar cell installation comprising: at least one solar cell mounted in an elevated position to receive solar radiation, said solar cell having a DC output connected via a DC cable to an inverter to convert said DC output into an AC output, wherein a cut-out switch is located in an elevated position adjacent said at least one solar cell and is operable to disconnect said DC output from said DC cable, and wherein said cut-out switch is operable by an elongated actuator which extends from said cut-out switch to an un-elevated position at or near ground level.

2. The installation as claimed in claim 1, wherein said actuator comprises a cable slideably mounted within a sleeve having a lower end, the lower end of said cable incorporating a handle.

3. The installation as claimed in claim 2 wherein said actuator is not reversible to reconnect said DC output and said DC cable.

4. A method of isolating at least one solar cell mounted in an elevated position to receive solar radiation and producing a DC output, said method comprising:
interposing a cut-out switch in a DC cable interconnecting said solar cells with an inverter to produce an AC output, said cut-out switch being located in an elevated location adjacent said solar cells and being operable to disconnect said DC output from said DC cable;
connecting said cut-out switch to an elongated actuator which extends from said cut-out switch to an un-elevated position at, or near, ground level; and
operating said actuator to disconnect said DC cable from said solar cell.

5. The method as claimed in claim 4 including the step of:
forming said actuator such that reversing said actuator does not re-connect said DC cable and said solar cell.

6. A cut-out switch operable remotely by an elongated actuator, said switch comprising a fireproof housing, a switch located inside said housing, and an elongated actuator having two ends, one of said two ends being connected with said switch to open and close same and the other of said two ends having an operating handle.

7. A solar cell installation including the cut-out switch as claimed in claim 6.
